(19) United States
(12) Patent Application Publication
(10) Pub. No.: US 2011/0205757 A1
(43) Pub. Date: Aug. 25, 2011

(54) THIN LIGHT EMITTING MODULAR PANEL SYSTEM

(76) Inventor: Robert H. Whyte, Austin, TX (US)

(21) Appl. No.: 13/030,965

(22) Filed: Feb. 18, 2011

Related U.S. Application Data
(60) Provisional application No. 61/306,785, filed on Feb. 22, 2010.

(51) Int. Cl. F21V 7/22

(52) U.S. Cl. 362/607

(57) ABSTRACT

An improved and novel system is needed to provide a lighting to a room using light emitting diode (“LED”). The novel system utilizes a thin edge panel composed of LEDs, plates and a polycarbonate material. The plates are manufactured from injection molded technology and include guides to allow various panels to be connected to one another. The novel system can be secured to ceilings and walls to provide an efficient and cost effective lighting solution in lieu of current lighting systems, such as fluorescent lighting systems.

### CROSS-REFERENCE TO RELATED APPLICATIONS

This application claims the benefit of U.S. Provisional Application No. 61/306,785 filed on Feb. 22, 2010, which application is hereby incorporated by reference for all purposes in its entirety.

### STATEMENT REGARDING FEDERALLY SPONSORED RESEARCH OR DEVELOPMENT

N/A

### REFERENCE TO MICROFICHE APPENDIX

N/A

### BACKGROUND OF THE INVENTION

1. Field of the Invention

The present invention is directed to an apparatus and method for effectively and efficiently emitting light along an edge of a panel for use in illuminating a room or other area with white light. The panel is modular in design and can be inter-connected with other panels to create a cost efficient lighting system.

2. Description of the Related Art

Different lighting means from candles to incandescent lighting have been around for many years. One popular cost efficient form of lighting, known as “fluorescent lighting” is currently used in homes and businesses. Such lighting provides greater illumination at a lower price. One of the first inventors of commercial fluorescent lighting is Albert Hull of the General Electric Company. The patent (U.S. Pat. No. 1,790,153) issued in 1931 disclosed an electrical discharger device and method of operation. In principle, fluorescent lighting relies upon an electrical source, electrical control circuitry and a fluorescent tube. The fluorescent tube includes a glass tube and a fluorescence. Inside the glass tube is a partial vacuum and a small amount of mercury. An electrical discharge in the tube causes the mercury atoms to emit ultraviolet light. The glass tube is lined with a coating of a fluorescent material which absorbs the ultraviolet and re-emits visible light. The glass tubes are typically installed in a housing that re-directs the light to area of interest. Although somewhat cost effective, fluorescent lighting suffers from certain limitations such as the appearance of un-natural lighting and emit unhealthily vibrations (e.g., humming). Furthermore, the fluorescent tube contains toxic materials that are a health and safety concern. In addition, in this era where the costs of energy is skyrocketing and “green” technology is sought to reduce carbon and other greenhouse emissions, newer technologies are needed to improve white lighting to meet the necessary light level standards for a given application.

### BRIEF SUMMARY OF THE INVENTION

An improved and novel system are needed to illuminate an area with white light using a light emitting diode (“LED”) technology. The system uses an array of LEDs that are mounted on a board. The LED board is housed along an edge of a modular injection molded light plate. An injection molded back plate then interfaces with the light plate to create a modular lighting panel. The LEDs are mounted in the light plate to allow the light from the LEDs to project inwards towards the center of the plate and then re-directed towards a diffuser and then through the lighting panel for illuminating an area. The novel system can be used to replace existing lighting fixtures. The modular panel can be connected to other modular panels to create the necessary size and lighting requirements for a particular application. The use of this novel system conserves electrical power consumption and provides an extended life span yet meets the lighting level standards for illuminating an area with white light. Furthermore, the panel includes a small (thin) profile in view of the use of LEDs and is manufactured by injection molded technology which reduces manufacturing costs, reduces weight and reduces the number of connection parts.

### BRIEF DESCRIPTION OF THE DRAWINGS

A better understanding of the present invention can be obtained with the attached drawings, slides and photographs of the various disclosed embodiments, which are given by way of illustration only, and thus are not limiting the present invention.

FIG. 1 is a top view of an embodiment of the present invention.

FIG. 2 is a cross section view of a corner of an embodiment of the present invention.

FIG. 3 is a cross section view of an embodiment of the present invention.

FIG. 4 is a bottom view of an embodiment of the present invention.

FIG. 5 is a cross section view of a corner of an embodiment of the present invention.

FIG. 6 is a cross section view of a corner of an embodiment of the present invention.

FIG. 7 is a corner view of an embodiment of the present invention.

FIG. 8 is a top view of an embodiment of the present invention.

FIG. 9 is a top view of an embodiment of the present invention.

FIG. 10 is a cross section view of an embodiment of the present invention.

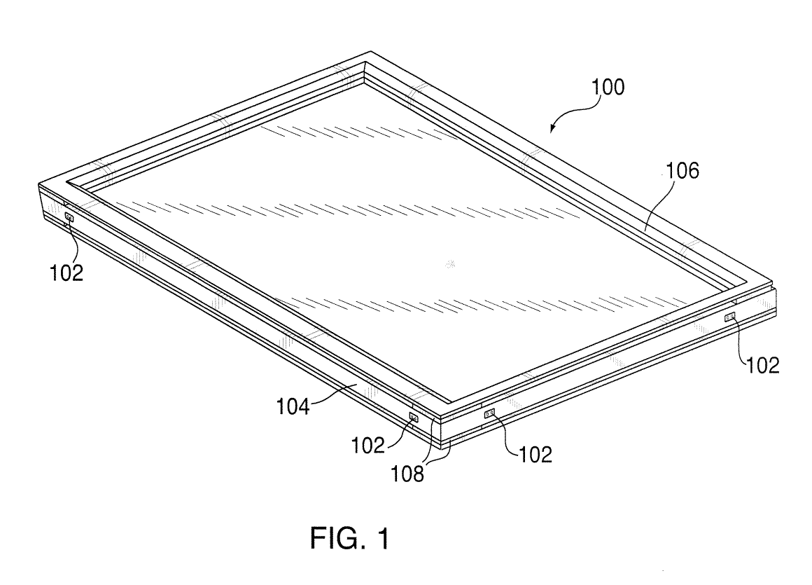

In one embodiment and as illustrated in FIG. 1, a modular lighting panel 100 for generating white light includes a back plate 104 and a light plate 106. The light plate 104 includes electrical connectors 102 and mounting guides 108. As will be illustrated in other figures, the back plate 104 and the light plate 106 are connected together to form the modular lighting panel 100. The plates are connected together using joints (such as dovetail joints) so that connecting hardware is avoided. Since the plates are made of injection molded materials, the plates (and joint areas) can be pushed together to form the completed modular panel.

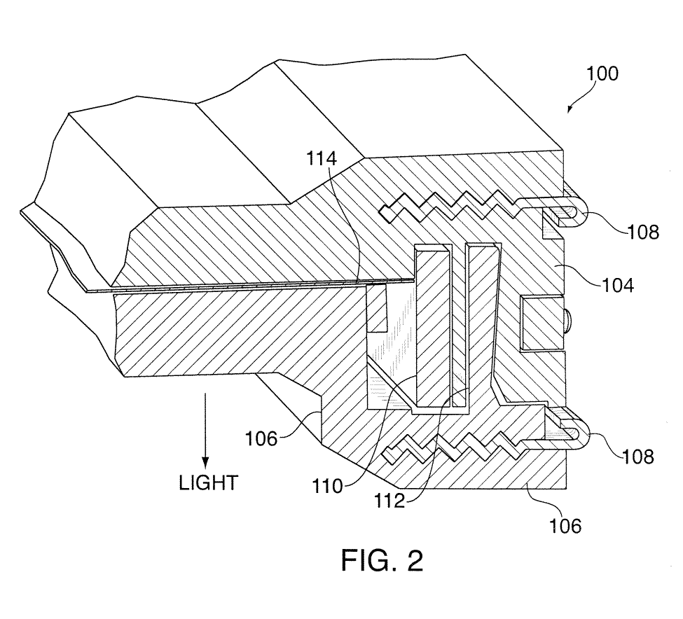

A cross section view of two sides of the modular lighting panel 100 is illustrated in FIG. 2. In one embodiment, the modular lighting panel 100 comprises an injection molded back plate 104 and an injection molded lighting plate 106. The mounting guides 108 are constructed with a metal material and are inserted into the back plate 104 during the injection molding process. Once the back plate 104 cures, the mounting guides 108 are secured into place within the back plate 104. An LED board 110 is affixed along a support edge 112 of the lighting plate 106. The LED board 110 is oriented so that light emitting from the board 110 is directed inwards within the lighting plate 106. Although not shown, several LED boards 110 can be included on the different edges of the panel 100. In addition, not shown is a power converter for supplying power from an electrical outlet to the LED board 110. Also, various types of LEDs can be used on the board 110 to create a overall desired lighting condition (such as daylight, cool, white and warm light temperatures). Channels are provided in the plates to allow electrical wires to be routed through the plates. The brightness of the LEDs can be controlled by a dimmer circuit.

The light from the LED board 110 is directed to an edge of the lighting plate 106. The lighting plate 106 is made of a polycarbonate material and can be manufactured using injection molding technology. A light reflecting film 114 is generally positioned between the back plate 104 and the lighting plate 106 to direct any light towards the lighting plate 106. The light reflecting film 114 typically is less than .2 mm thick and on the side facing the lighting plate 106, the film 114 includes a reflective coating. The film 114 facing the back plate 104 typically includes a non-reflective coating. The exterior surface of the lighting plate 106 includes a combination of inks that promote the collection and refraction of the light in a certain direction (in the present embodiment, the collected light is directed away from the exterior surface of the lighting plate 106). The combination of inks forms a pattern on the lighting plate 106 so that the light from the LED board 110 is reflected between the film 114 and the interior structure of the lighting plate 106 so that the light exiting the lighting plate 106 is evenly distributed. Some of the light that does not initially exit the lighting plate 106 is re-directed towards the film 114 and then re-directed towards the exterior surface of the lighting plate 106. The re-direction of light rays between the film 114 and the lighting plate 106 produces the desired light from the panel 100 to illuminate an area.

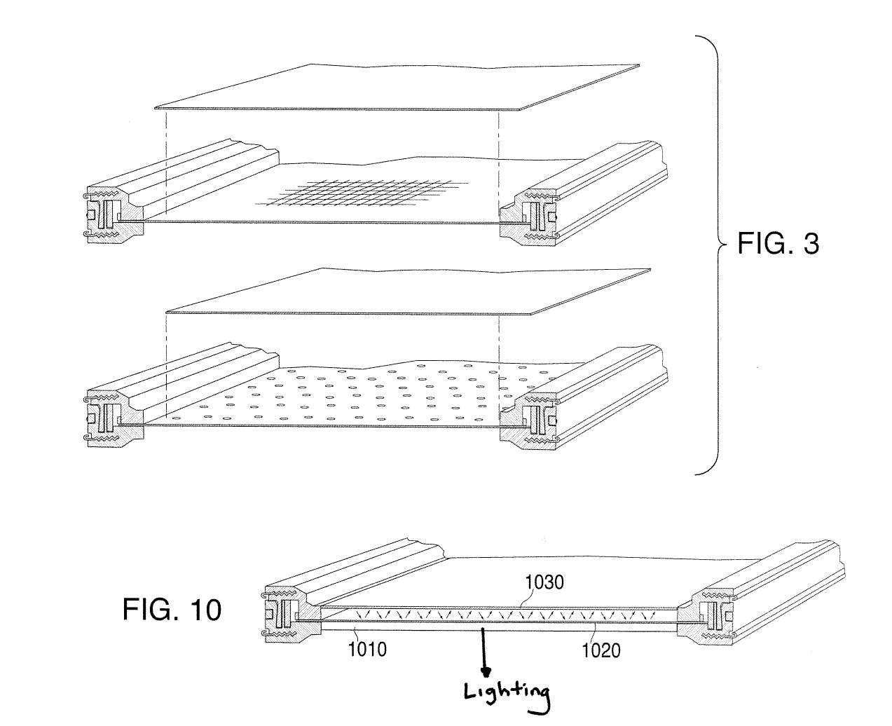

In another embodiment and as illustrated in FIG. 3, the pattern is created in the lighting panel 106 during the injection molding process. The pattern could be formed of dimples or V line etchings in the exterior surface of the lighting plate 106.

FIG. 4 illustrates the back plate 400. The back panel is manufactured by injection molding technology. To provide rigidity to the back plate 400, the back plate 400 includes horizontal and vertical ribs 402.

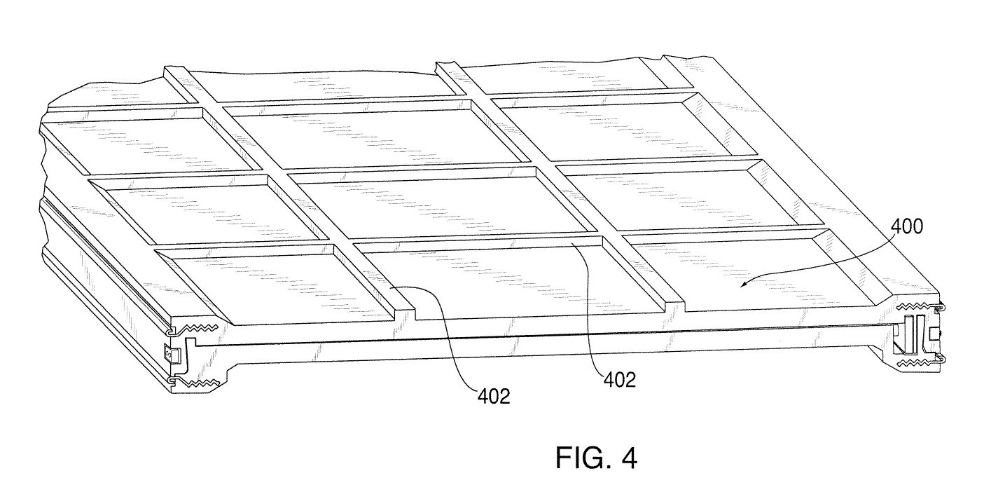

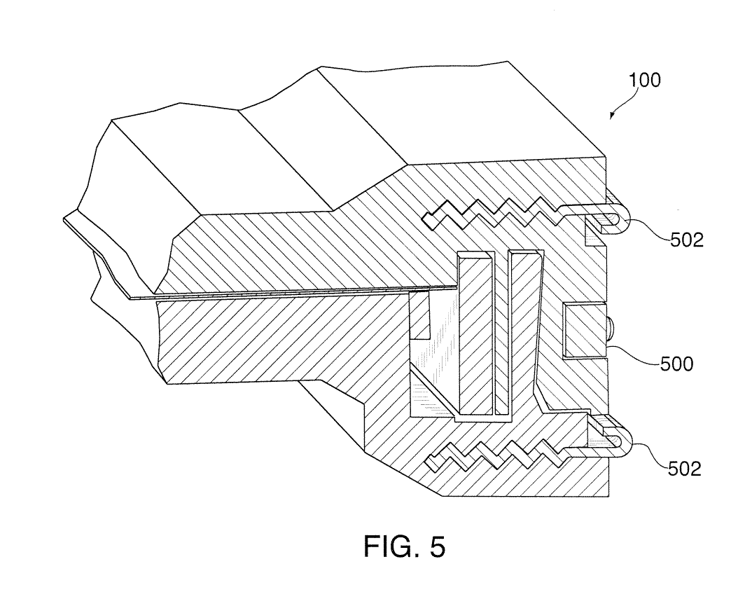

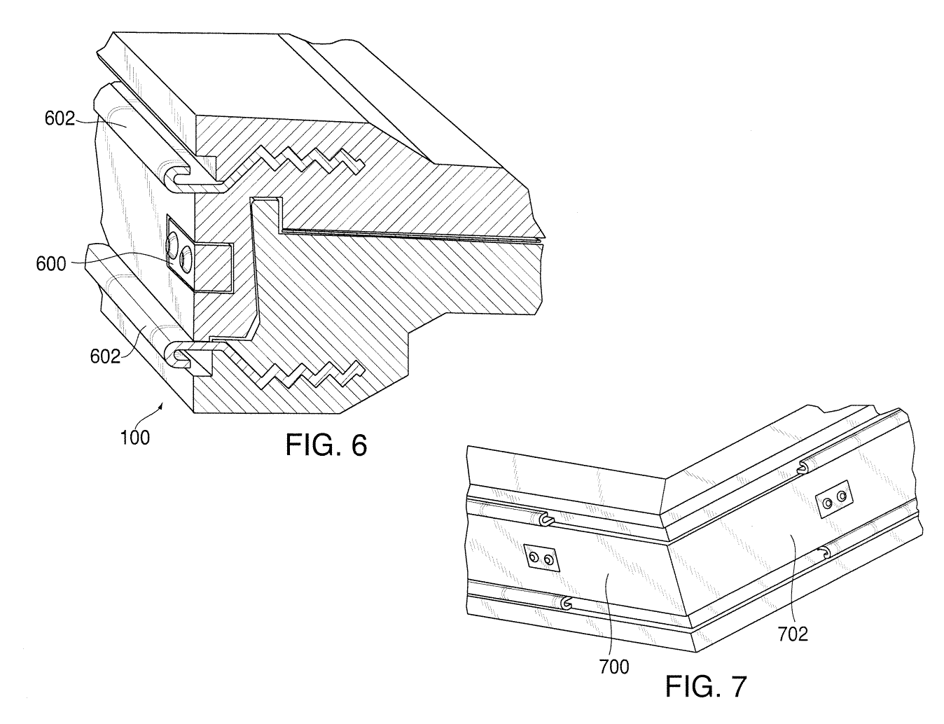

FIGS. 5 and 6 illustrate edge views of two modular lighting panels. In FIG. 5, the modular panel 100 includes an electrical connector 500, such as a pogo switch. The panel 100 includes two metal guides 502. In FIG. 6, a corresponding modular panel 100 is shown. When the panels 100 are connected together, the mounting guides 502 and 602 slide together to form a secure physical connection. When the panels 100 are connected properly, the electrical connectors 500 and 600 are in electrical contact with one another. The panel 100 consumes less electrical power, weigh less yet provide greater lumen and lux over standard fluorescent lighting systems.

FIG. 7 illustrates two sides of the modular panel 100. The other two sides of the panel (not shown) also include similar mounting guides and electrical connections. The two sides 700 and 702 indicate that the panel 100 can be connected to other panels on any sides.

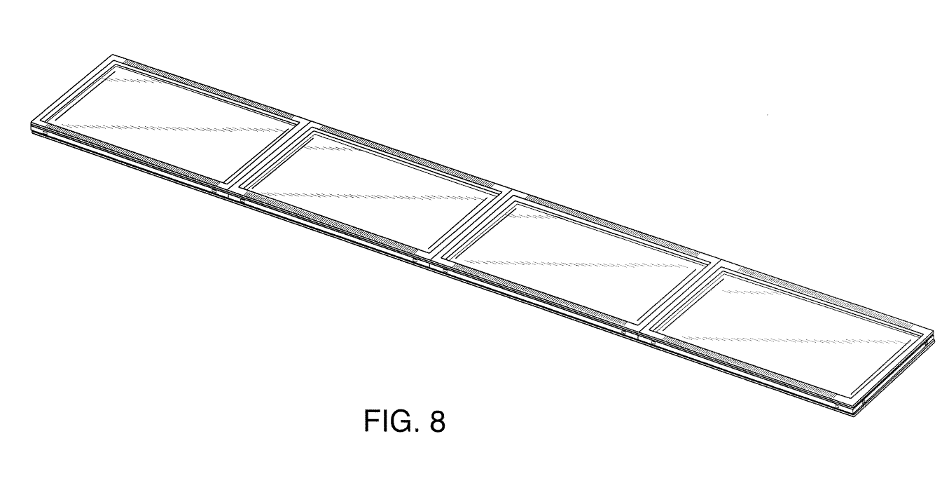

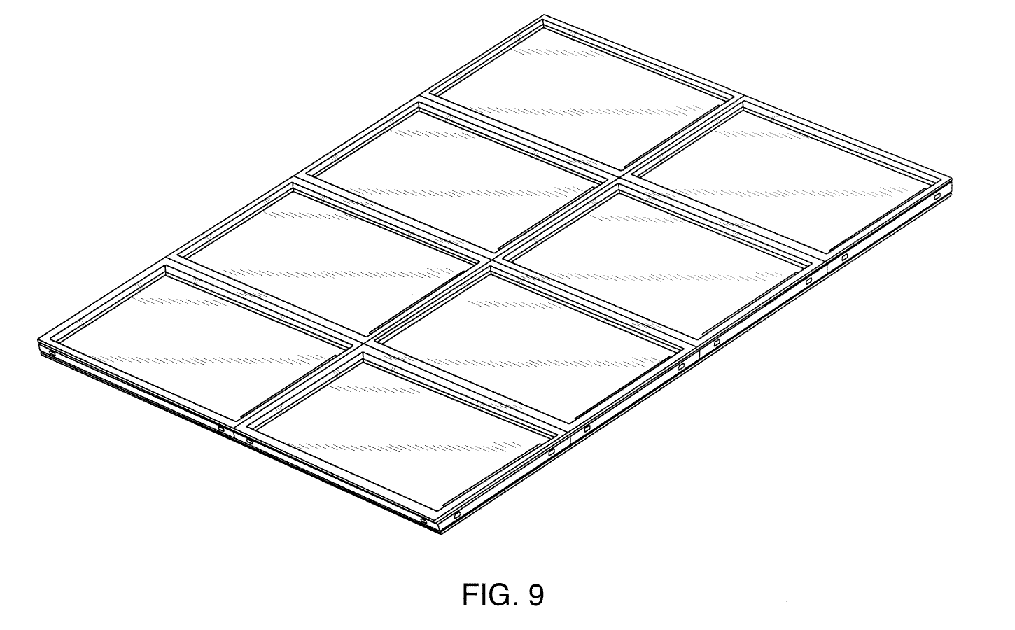

FIGS. 8 and 9 illustrate the panels 100 connected in various configurations. The modular design of the panels 100 allows the end users to customize the panels to meet their lighting requirements. For installation of multiple panels 100, additional supporting connectors (or braces) (not shown) are used to ensure that the overall panels can be mounted and installed securely.

FIG. 10 illustrates a cross section of a panel 100. The panel 100 includes a back plate 1010 and a lighting plate 1020. Between the plates is a reflecting film 1030. An LED 1040 provides a light source to the lighting plate 1020. Light is reflected between the film 1030 and lighting plate 1020 before existing the lighting panel 100.

The photographs and description of the invention are illustrative and explanatory thereof, and various changes in the details of the illustrated apparatus and system, and the construction and the method of operation may be made without departing from the spirit of the invention.

I claim:

1. A modular panel system for illuminating a room, comprising:
a first modular panel and a second modular panel;
said first modular panel and said second modular panel each comprising:
a light plate, including an inner edge, an interior surface and an exterior surface, said light plate comprised of material for amplifying a plurality of light sources;
said plurality of light sources positioned along the inner edge of the light plate, said light sources positioned to direct a lighting from the light sources towards the light plate, wherein said light plate including a first joint;
a back plate including a second joint for connecting said light plate with said back plate;
a reflective film positioned between the light plate and the back plate; and
mounting guides, wherein said mounting guides are used to secure said first modular panel with said second modular panel.

2. The system of claim 1, further comprising a plurality of patterns, said patterns positioned on the exterior surface of the light plate, said patterns collecting and refracting said lighting between said light plate and said reflective film wherein said lighting is distributed to the room.

3. The system of claim 1, wherein the light plate and the back plate are comprised of an injection molded material.

4. The system of claim 3, wherein the injection molded material is a polycarbonate material.

5. The system of claim 1, wherein the first joint is a male joint.

6. The system of claim 5, wherein the second joint is a female joint.

7. The system of claim 1, wherein the light sources are comprised of a plurality of light emitting diodes.

8. The system of claim 1, wherein the plurality of lighting sources are attached to an aluminum frame.

9. The system of claim 2, wherein the patterns are comprised of a plurality of dots.

10. The system of claim 9, wherein the light plate is comprised of an acrylic sheet.

11. The system of claim 10, wherein the reflective film is comprised of a white material.

12. The system of claim 11, further comprising a power converter for supplying power to the light sources.

13. The system of claim 12, wherein the first modular panel and second modular panel includes electrical connectors for supplying power from the first modular panel to the second modular panel.

14. The system of claim 13, wherein the electrical connectors are comprised of pogo switches.

15. A lighting system for illuminating a room, comprising:
a light plate, including an inner edge, an interior surface and an exterior surface, said light plate comprised of material for amplifying a plurality of light sources;
said plurality of light sources positioned along the inner edge of the light plate, said light sources positioned to direct a lighting from the light sources towards the light plate, wherein said light plate including a first joint;
a back plate including a second joint for connecting said light plate with said back plate;
a reflective film positioned between the light plate and the back plate; and
a plurality of patterns, said patterns positioned on the exterior surface of the light plate, said patterns collecting and refracting said lighting between said light plate and said reflective film wherein said lighting is distributed to the room.

16. The system of claim 15, wherein the light plate and the back plate are comprised of an injection molded material.

17. The system of claim 16, wherein the light sources are comprised of a plurality of light emitting diodes.

18. The system of claim 16, wherein the patterns are comprised of a plurality of dots.

19. The system of claim 18, where the light emitting diodes provide cool white illumination.

20. A method for illuminating a room, comprising the steps of:
illuminating an opaque material with a light source, wherein the opaque material includes a top side and a bottom side and wherein a reflective film is attached to the top side of the opaque material;
reflecting a plurality of light rays from the light source between the reflective film and the bottom side of the opaque material; and
amplifying and distributing the light rays from the bottom side of the opaque material.
